(19) United States
(12) Patent Application Publication
(10) Pub. No.: US 2018/0031941 A1
(43) Pub. Date: Feb. 1, 2018

(54) MULTI-ELECTRODE TOTAL INTERNAL REFLECTION IMAGE DISPLAY

(71) Applicants: CLEARink Displays, Inc., FREMONT, CA (US); Merck Patent GmBH, Darmstadt (DE)

(72) Inventors: Mark GOULDING, Hampshire (GB); Nathan SMITH, Southampton (GB); Rob HANNEBAUER, Vancouver (CA)

(21) Appl. No.: 15/550,488

(22) PCT Filed: Feb. 10, 2016
(86) PCT No.: PCT/US16/17416

§ 371 Date: Aug. 11, 2017

Related U.S. Application Data
(60) Provisional application No. 62/115,361, filed on Feb. 12, 2015.

(51) Int. Cl. G02F 1/167; G02F 1/137; G02F 1/133

(52) U.S. Cl. CPC G02F 1/167; G02F 1/13306; G02F 1/137; G02F 2001/1676; G02F 2201/124; G02F 2203/023

(57) ABSTRACT

Conventional total internal reflection image displays consist of mobile particles of a single charge and capable of displaying information consisting of two different optical states. The reflective image display embodiments described herein comprises particles of different charge states and optical characteristics in combination with multi-electrode arrays. This may allow for displaying information consisting of at least three different optical states.

This application claims the filing date benefit of U.S. Provisional Application No. 62/115,361, filed on Feb. 12, 2015, the entirety of which is incorporated herein by reference.

### FIELD

The instant disclosure is directed to a method and apparatus for total internal reflection-based image displays. Specifically, an embodiment of the disclosure relates to reflective image displays capable of displaying images composed of at least three different color states with a multi-electrode design.

Light modulation in conventional single particle total internal reflection (TIR) image displays are controlled by movement of a plurality of light absorbing electrophoretically mobile particles into and out of the evanescent wave region at the surface of the front sheet comprising of convex protrusions under an applied voltage across the electrophoretic medium. The particles may have either a positive or negative charge with a single optical characteristic. A first optical state of the display may be formed when the particles are attracted to the evanescent wave region where incident light rays are absorbed by the mobile particles (referred to as the dark state). A second optical state may be displayed when the particles are moved out of the evanescent wave region towards a rear electrode where light rays may be totally internally reflected to form a light or bright state.

This application describes a two-particle TIR image display comprising a plurality of particles of opposite charge polarity and different optical characteristics capable of forming at least three different optical states. TIR may be frustrated to create light absorbing or dark states by application of a voltage bias and moving either the plurality of positively or plurality of negatively charged particles into the evanescent wave region. A third optical state may be formed by moving both pluralities of particles out of the evanescent wave region. This disclosure further describes multi-electrode display architectures. The combination of particles of opposite charge polarity and different optical characteristics in combination with multi-electrode display architectures leads to TIR image displays capable of displaying images with multiple colors that is described herein.

### BRIEF DESCRIPTION OF DRAWINGS

These and other embodiments of the disclosure will be discussed with reference to the following exemplary and non-limiting illustrations, in which like elements are numbered similarly, and where:

FIG. 1A schematically illustrates a cross-section of a portion of a total internal reflection image display comprising oppositely charged particles and three electrodes in a first optical state according to one embodiment of the disclosure;

FIG. 1B schematically illustrates a cross-section of a portion of a total internal reflection image display comprising oppositely charged particles and three electrodes in a second optical state according to one embodiment of the disclosure;

FIG. 1C schematically illustrates a cross-section of a portion of a total internal reflection image display comprising oppositely charged particles and three electrodes in a third optical state according to one embodiment of the disclosure;

FIG. 2A schematically illustrates a cross-section of a portion of a total internal reflection image display comprising oppositely charged particles and interdigitated rear electrodes in a first optical state according to one embodiment of the disclosure;

FIG. 2B schematically illustrates a cross-section of a portion of a total internal reflection image display comprising oppositely charged particles and interdigitated rear electrodes in a second optical state according to one embodiment of the disclosure;

FIG. 2C schematically illustrates a cross-section of a portion of a total internal reflection image display comprising oppositely charged particles and interdigitated rear electrodes in a third optical state according to one embodiment of the disclosure;

FIG. 3A schematically illustrates a cross-section of a portion of a total internal reflection image display comprising oppositely charged particles, interdigitated rear electrodes and a reflective layer in a first optical state according to one embodiment of the disclosure;

FIG. 3B schematically illustrates a cross-section of a portion of a total internal reflection image display comprising oppositely charged particles, interdigitated rear electrodes and a reflective layer in a second optical state according to one embodiment of the disclosure;

FIG. 3C schematically illustrates a cross-section of a portion of a total internal reflection image display comprising oppositely charged particles, interdigitated rear electrodes and a reflective layer in a third optical state according to one embodiment of the disclosure; and

FIG. 4 schematically illustrates an exemplary system for implementing an embodiment of the disclosure.

### DETAILED DESCRIPTION

The exemplary embodiments provided herein describes total internal reflection-based image displays capable of displaying at least three different colors. In an exemplary embodiment, the disclosure provides a total internal reflection-based image display comprising a first and second plurality of electrophoretically mobile particles of different charge polarity and color and three electrodes that may be independently controlled. When the first plurality of particles may be moved into the evanescent wave region a first color may be exhibited. When the second plurality of particles may be moved into the evanescent wave region a second color may be exhibited. When both the first and second plurality of particles are moved out of the evanescent wave region, a third color may be exhibited.

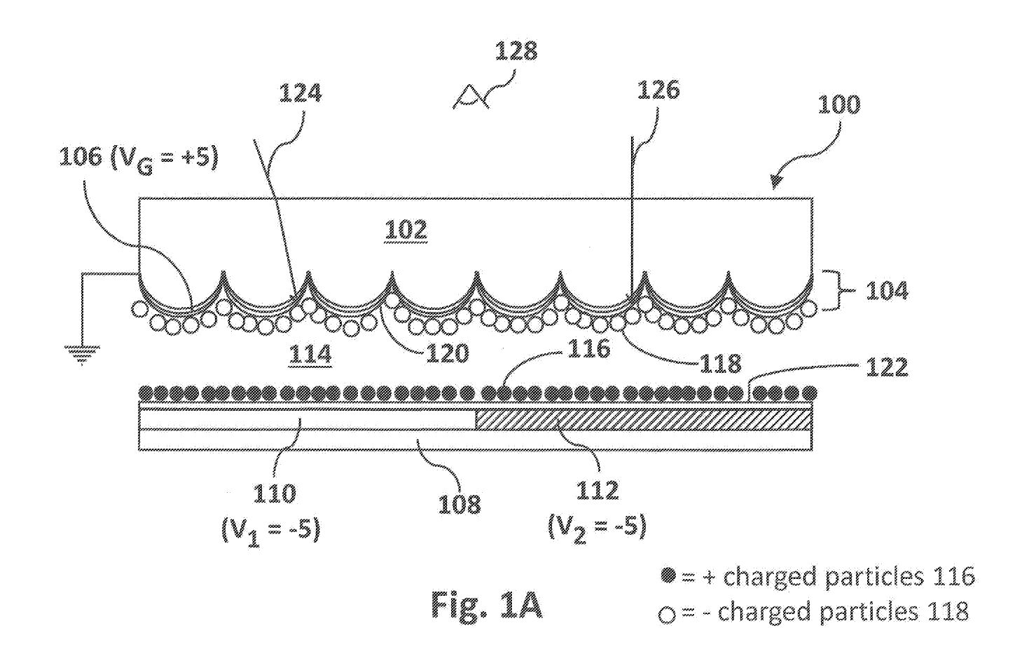

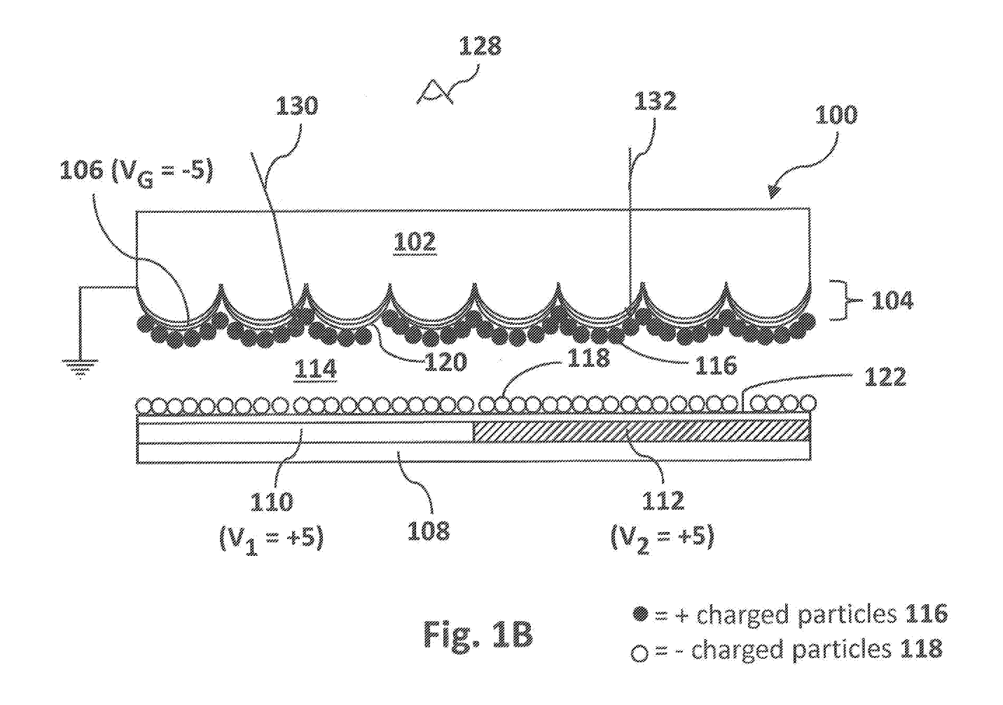

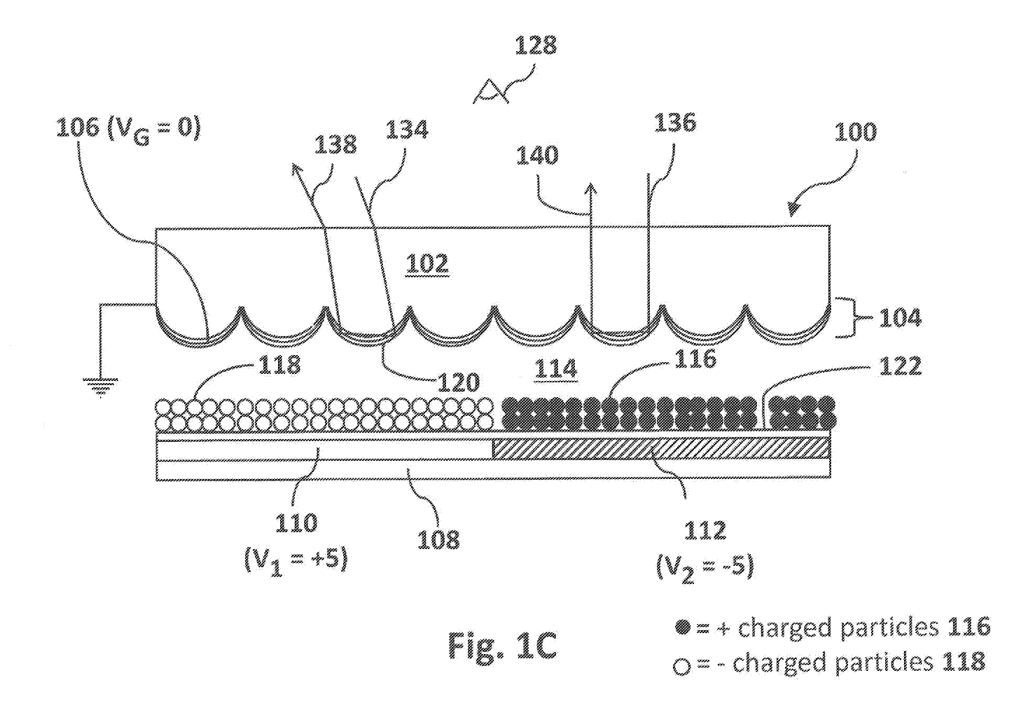

FIG. 1A schematically illustrates a cross-section of a portion of a total internal reflection image display comprising oppositely charged particles and three electrodes in a first optical state according to one embodiment of the disclosure. Display 100 in FIG. 1A comprises a transparent front sheet 102 containing a plurality of partially embedded high refractive index transparent hemispherical beads 104 in the inward surface, a grounded transparent front electrode layer 106 on the surface of the hemispherical beads and a rear support 108. Rear support 108 may be further equipped with two rear electrodes 110 and 112 such as in a thin film transistor or patterned electrode array and a voltage source (not shown) that connects the front and rear electrodes.

Alternatively, transparent front sheet 102 may define a continuous, high refractive index transparent sheet with convex protrusions. The convex protrusions may be in the shape of hemispherical protrusions as illustrated in FIG. 1A. Front sheet 102 may comprise a polymer such as polycarbonate. Front electrode 106 may comprise a transparent conductive material such as indium tin oxide (ITO), Baytron™, conductive nanoparticles, metal, nanowires, graphene or other conductive carbon allotropes or a combination of these materials dispersed in a substantially transparent polymer.

Rear electrode 110, 112 may comprise a conductive material such as indium tin oxide (ITO), conductive particles, metal nanowires, Baytron™, graphene or other conductive carbon allotropes or a combination thereof dispersed in a polymer or a metallic-based conductive material (e.g., aluminum, gold or silver). Rear electrodes 110, 112 may comprise one or more of a thin film transistor (TFT) array, direct drive patterned array of electrodes or a passive matrix array of electrodes.

Contained within the cavity formed by the front electrode 106 and rear electrodes 110, 112 may be an inert, low refractive index air or fluid medium 114. Medium 114 may be a hydrocarbon. In an exemplary embodiment, medium 114 may be a fluorinated hydrocarbon or a perfluorinated hydrocarbon. In an exemplary embodiment, medium 322 may be Fluorinert™ perfluorinated hydrocarbon liquid available from 3M, St. Paul, Minn.

Medium 114 may further include a plurality of suspended light absorbing electrophoretically mobile particles 116, 118. In an exemplary embodiment, medium 114 has a lower refractive index than front sheet 102. The cavity formed between front electrode 106 and rear electrodes 110, 112 may further comprise spacer units (not shown) such as beads to control the size of the gap between the front and rear electrodes. The spacer units may comprise glass, metal or an organic polymer.

Mobile particles 116 comprise a first charge polarity and first optical characteristic (i.e. color). Mobile particles 118 comprise a second charge of opposite polarity and a second optical characteristic. Particles 116 or 118 may be any color of the visible spectrum or a combination of colors to give a specific shade or hue. Particles 116, 118 may be formed of an organic material or an inorganic material or a combination of an organic and inorganic material. Particles 116, 118 may be a dye or a pigment or a combination thereof. Particles 116, 118 may be at least one of carbon black, a metal or metal oxide. The particles may have a polymer coating. In one embodiment, particles 116 illustrated in display 100 in FIG. 1A may consist of a positive charge polarity while particles 118 consist of a negative charge polarity.

The exemplary embodiment of display 100 further includes an optional dielectric layer 120 located on the surface of transparent front electrode 106 and disposed between transparent front electrode 106 and medium 114. FIG. 1A illustrates a dielectric layer 122 on the surface of the rear electrodes 110, 112 in display 100 such that dielectric layer 122 is disposed between the rear electrodes 110, 112 and medium 114. Having a dielectric layer on the rear electrode may be optional and may depend on the composition of the rear electrode. The dielectric layers may be used to protect one or both of the front electrode layer 106 and rear electrode layers 110, 112. The dielectric layers may be substantially uniform, continuous and defect-free layer of as least about 20 nanometers in thickness. Dielectric compounds may be organic or inorganic in type. The most common inorganic dielectric material is silicon dioxide commonly used in integrated chips. Organic dielectric materials are typically polymers such as polyimides, fluoropolymers, polynorbornenes and hydrocarbon-based polymers lacking polar groups. In an exemplary embodiment, the dielectric layers comprise parylene. In another embodiment the dielectric layers comprises a halogenated parylene. Other inorganic or organic dielectric materials or combinations thereof may also be used for the dielectric layers.

The dielectric layers may each have a thickness of at least 80 nanometers. In an exemplary embodiment, the thickness is about 80-200 nanometers. Advantageously, parylene has a low dielectric constant and may be made as thin as 20 nanometers without having pinhole leakage paths. Such features contribute to display structures having a comparatively high capacitance per unit area. The high capacitance means that the required number per unit area of charged mobile particles may be attracted to the parylene at a lower voltage than if the thickness was higher or if the dielectric constant was lower.

Referring again to FIG. 1A, display 100 illustrates a pixel of the display in a first optical state. The optical state may be created by absorption of incident light rays by negatively charged particles 118 of a first optical characteristic. In this state, the electrophoretically mobile positively charged particles 116 may be moved under the influence of an applied voltage bias towards rear electrode surfaces 110, 112. In the example in FIG. 1A, rear electrodes 110, 112 have an applied voltage bias V₁ and V₂, respectively, of −5V (It should be noted that other voltage biases of varying magnitudes may be applied as −5V is used for illustrative purposes only). The negatively charged particles 118 may be moved near the front dielectric layer adjacent the grounded front electrode surface 106 that has a +5V bias (V_{G}) into the evanescent wave region such that TIR is frustrated and incident light rays are absorbed. This is illustrated by incident light rays 124 and 126 that may be absorbed by the negatively charged particles 118 whereby the portion of the display in FIG. 1A observed by viewer 128 exhibits the optical characteristic (i.e. color) of the negatively charged particles 118.

FIG. 1B schematically illustrates a cross-section of a portion of a total internal reflection image display comprising oppositely charged particles and three electrodes in a second optical state according to one embodiment of the disclosure. Display 100 in FIG. 1B is the same as that described in FIG. 1A in the preceding paragraphs but illustrates how a second optical state may be formed. Display 100 in FIG. 1B illustrates a pixel of the display in a second optical state created by absorption of incident light rays by positively charged particles 116 having a second optical characteristic. In this state, electrophorectically mobile particles 118 with a negative charge polarity may be moved under the influence of an applied voltage bias near dielectric layer 120 adjacent to rear electrode surfaces 110, 112. In this example in FIG. 1B, the rear electrodes 110, 112 have an applied voltage bias V₁ and V₂, respectively, of +5V (It should be noted that other voltage biases of varying magnitudes may be applied as +5V is used for illustrative purposes only). Particles 116 of a positive charge polarity are moved near the front dielectric layer adjacent the grounded front electrode surface 106 that has a −5V bias (V_{G}) and into the evanescent wave region. When the particles enter the evanescent wave region and frustrate TIR, the incident light rays may be absorbed. This is illustrated by incident light rays 130 and 132 that may be absorbed by the positively charged particles 116. Thus the portion of the display in FIG. 1B observed by viewer 128 may exhibit the optical characteristic (i.e. color) of the positively charged particles 116.

FIG. 1C schematically illustrates a cross-section of a portion of a total internal reflection image display comprising oppositely charged particles and three electrodes in a third optical state according to one embodiment of the disclosure. Display 100 in FIG. 1C is the same as that described in FIGS. 1A-B in the preceding paragraphs but illustrates how a third optical state may be formed. In this state, mobile particles 116 with a positive charge polarity may be moved under the influence of an applied voltage bias, V₂, of −5V towards rear electrode 112. The mobile particles 118 with a negative charge polarity may be moved under the influence of an applied voltage bias, V₁, of +5V towards rear electrode 110. In this state of the display in FIG. 1C, there may be no particles in the evanescent wave region near grounded front electrode 106 which has a voltage bias, V_{G}, of 0V. Incident light rays 134 and 136 may be instead totally internally reflected back towards viewer 128 as reflected light rays 138 and 140, respectively, to create a light or bright state. This forms a third optical state of the display.

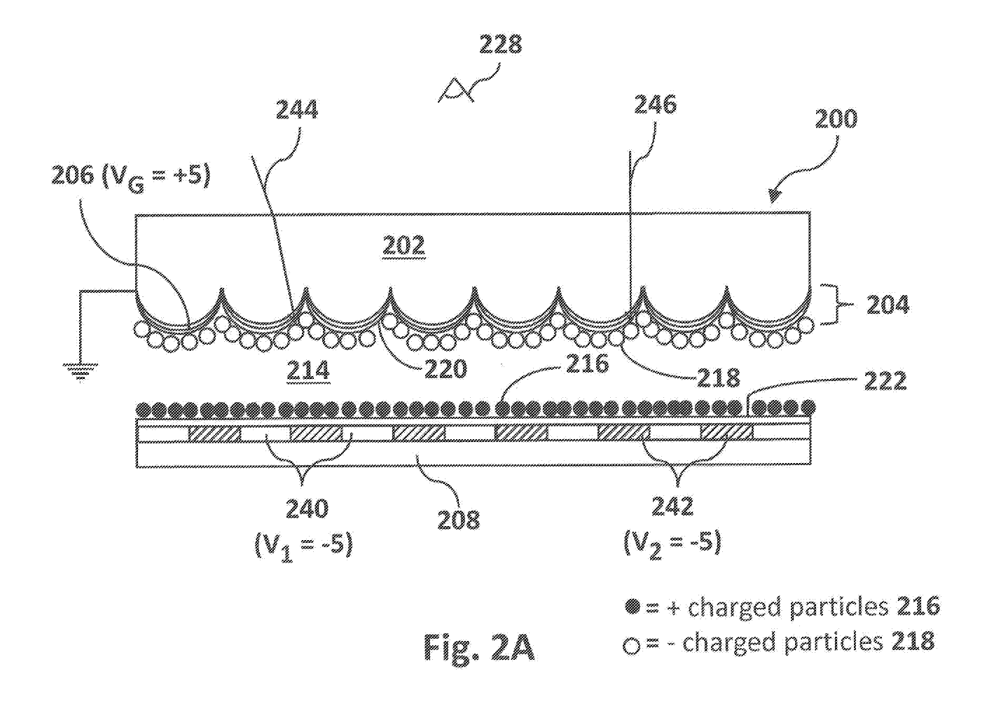

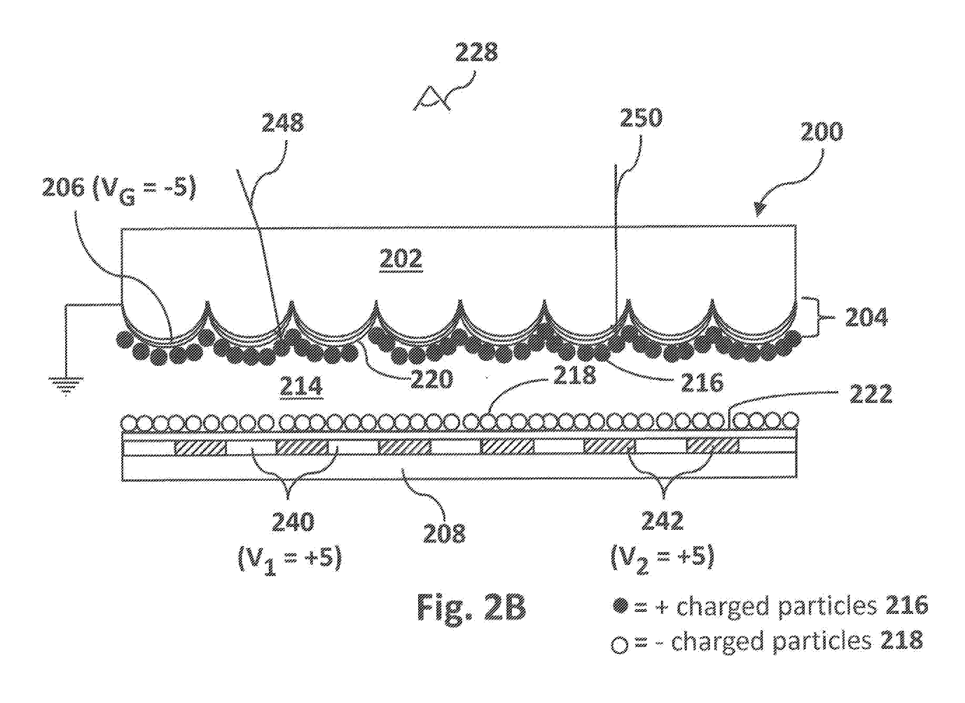

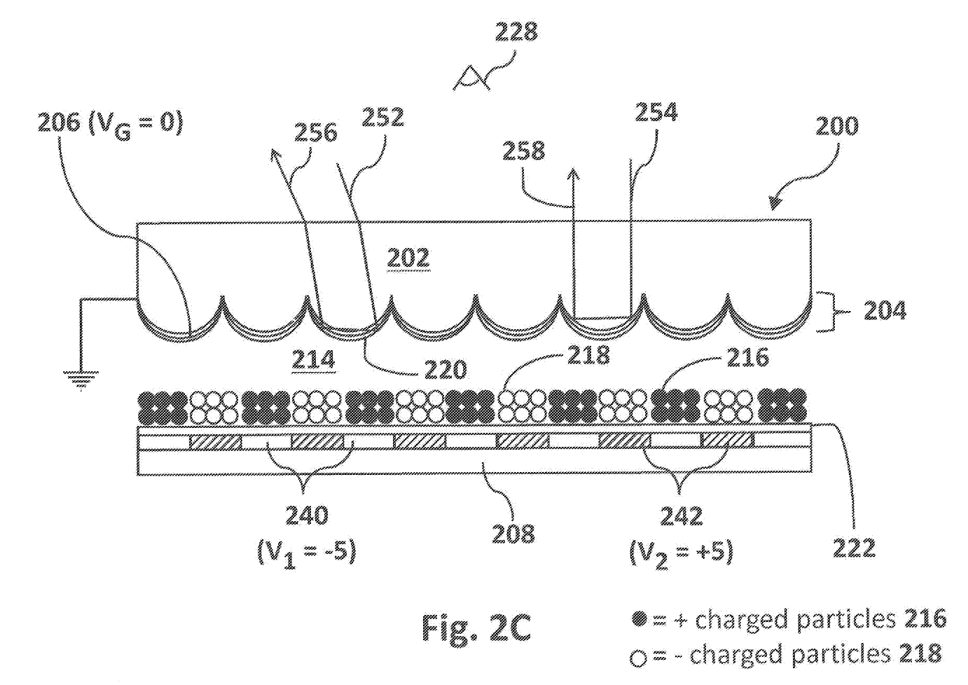

FIG. 2A schematically illustrates a cross-section of a portion of a total internal reflection image display comprising oppositely charged particles and interdigitated rear electrodes in a first optical state according to one embodiment of the disclosure. Display 200 in FIG. 2A is similar to display 100 in FIGS. 1A-C explained in preceding paragraphs but with some differences in the design of the rear electrodes. Display 100 has a first and second electrode in each pixel. Display 200 in FIG. 2A is of a pixel with an array of more than two interdigitated electrodes 240, 242. In an exemplary embodiment electrodes 240, 242 may be arrayed in an alternating fashion. In FIGS. 2A-C rear electrode 242 is highlighted by cross hatches to distinguish from adjacent electrodes 240. In other embodiments electrodes 240, 242 may be arranged in any periodic manner. Electrodes 240, 242 may be further supported by a rear support 208. A first plurality of electrodes 240 may be controlled by a first transistor and a second plurality of electrodes 242 may be controlled by a second transistor. Each plurality of electrodes 240 or 242 may consist of at least two electrodes. Ideally the width of electrodes 240, 242 would decrease as the number of electrodes increases per each pixel while keeping the dimensions of the pixel constant.

Multiple electrodes within each pixel may provide an additional advantageous feature of the display design in FIG. 2A. Multiple electrodes may lead to decreased lateral electric fields within the cavity containing medium 214 and mobile particles 216, 218. Reducing the lateral electric fields may reduce lateral movement and migration oi the particles. This may lead to a more uniform display performance. The cavity formed between the front dielectric layer 206 and rear dielectric layer 222 and rear electrodes 240, 242 in FIG. 2A may further comprise spacer units (not shown) such as beads to control the size of the gap between the front and rear electrodes.

The exemplary embodiment of display 200 may further include an optional dielectric layer 220 located on the surface of transparent front electrode 206 and disposed between transparent front electrode 206 and medium 214. Front electrode 206 is located on the inward side of transparent front sheet 202 where the plurality of protrusions 204 exists. FIG. 2A illustrates a dielectric layer 222 on the surface of the rear electrodes 240, 242 in display 200 such that the dielectric layer is disposed between the rear electrodes 240, 242 and medium 214. Having a dielectric layer on the rear electrodes may also be optional and may depend on the composition of the rear electrodes. The dielectric layers may each be a uniform layer of at least about 20 nanometers in thickness. Dielectric compounds may be organic or inorganic in type. The most common inorganic dielectric material silicon dioxide commonly used in integrated chips. Organic dielectric materials are typically polymers such as polyimides, fluoropolymers, polynorbornenes and hydrocarbon-based polymers lacking polar groups. In an exemplary embodiment, the dielectric layers comprise parylene. In another embodiment the dielectric layer comprises halogenated parylene. Other inorganic or organic dielectric materials or combinations thereof may also be used.

The dielectric layer may have a thickness of at least 80 nanometers. In an exemplary embodiment, the thickness is about 80-200 nanometers. Advantageously, parylene has a low dielectric constant and may be made as thin as 20 nanometers without having pinhole leakage paths. Such features contribute to display structures having a comparatively high capacitance per unit area. The high capacitance means that the required number per unit area of charged mobile particles may be attracted to the parylene at a lower voltage than if the thickness was higher or if the dielectric constant was lower.

Referring again to FIG. 2A, display 200 illustrates a pixel of the display in a first optical state. The optical state may be created by absorption of incident light rays by the particles 218 with a negative charge polarity and a first optical characteristic. In this state, the electrophoretically mobile particles 216 with a positive charge polarity may be moved under the influence of an applied voltage bias near the plurality of rear electrodes 240, 242. The plurality of electrode 240 and 242 may be interdigitated but it is not required for operation of display 200. In the example in FIG. 2A, the rear electrodes 240, 242 may have an applied voltage bias V₁ and V₂, respectively, of −5V (It should be noted that other voltage biases of varying magnitudes may be applied as −5V is used for illustrative purposes only). The negatively charged particles 218 may be moved near the front electrode surface 206 that has a +5V bias (V_{G}) into the evanescent wave region such that TIR is frustrated and incident light rays may be absorbed. This is illustrated by incident light rays 244 and 246 that are absorbed by the negatively charged particles 218. Thus the portion of the display in FIG. 2A observed by viewer 228 exhibits the optical characteristic (i.e. color) of the particles 218 with a negative charge polarity.

FIG. 2B schematically illustrates a cross-section of a portion of a total internal reflection image display comprising oppositely charged particles and interdigitated rear electrodes in a second optical state according to one embodiment of the disclosure. Display 200 in FIG. 2B is the same as that described in FIG. 2A in the preceding paragraphs but illustrates a second optical state. Display 200 in FIG. 2B illustrates a pixel of the display in a second optical state created by absorption of incident light rays by particles 216 with a positive charge polarity and a second optical characteristic. In this state, the electrophoretically mobile particles 218 with a negative charge polarity have been moved under the influence of an applied voltage bias towards rear electrodes 240, 242. In the example in FIG. 2B, rear electrodes 240, 242 have an applied voltage bias V₁ and V₂, respectively, of +5V (It should be noted that other voltage biases of varying magnitudes may be applied as +5V is used for illustrative purposes only). The positively charged particles 216 may be moved near the evanescent wave region adjacent the grounded front electrode surface 206 that has a −5V bias (V_{G}). In this position, particles 216 may frustrate TIR and absorb incident light rays. This is illustrated by incident light rays 248 and 250 in FIG. 2B that are absorbed by the positively charged particles 216. Thus the portion of the display in FIG. 2B observed by viewer 228 exhibits the optical characteristic (i.e. color) of the particles 216 with a positive charge polarity.

FIG. 2C schematically illustrates a cross-section of a portion of a total internal reflection image display comprising oppositely charged particles and interdigitated rear electrodes in a third optical state according to one embodiment of the disclosure. Display 200 in FIG. 2C is the same as that described in FIGS. 2A-B in the preceding paragraphs but exhibits a third optical state. In this state, the mobile positively charged particles 216 may be moved under the influence of an applied voltage bias, V₁, of −5V near rear electrode 240. The mobile negatively charged particles 218 have be moved under the influence of an applied voltage bias, V₂, of +5V near rear electrode 242. In this state of the display in FIG. 2C there may be no particles in the evanescent wave region near the grounded front electrode 206 which has a voltage bias, V_{G}, of 0V. Incident light rays 252 and 254 may instead be totally internally reflected back towards viewer 228 as reflected light rays 256 and 258, respectively, to create a light or bright state. This is a third optical state of the display.

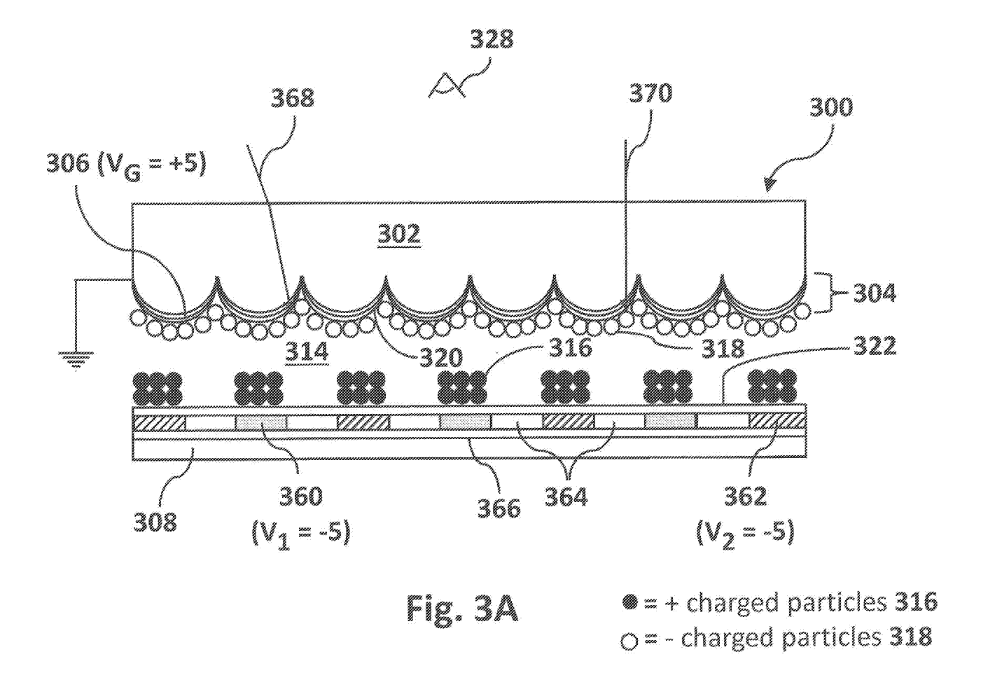

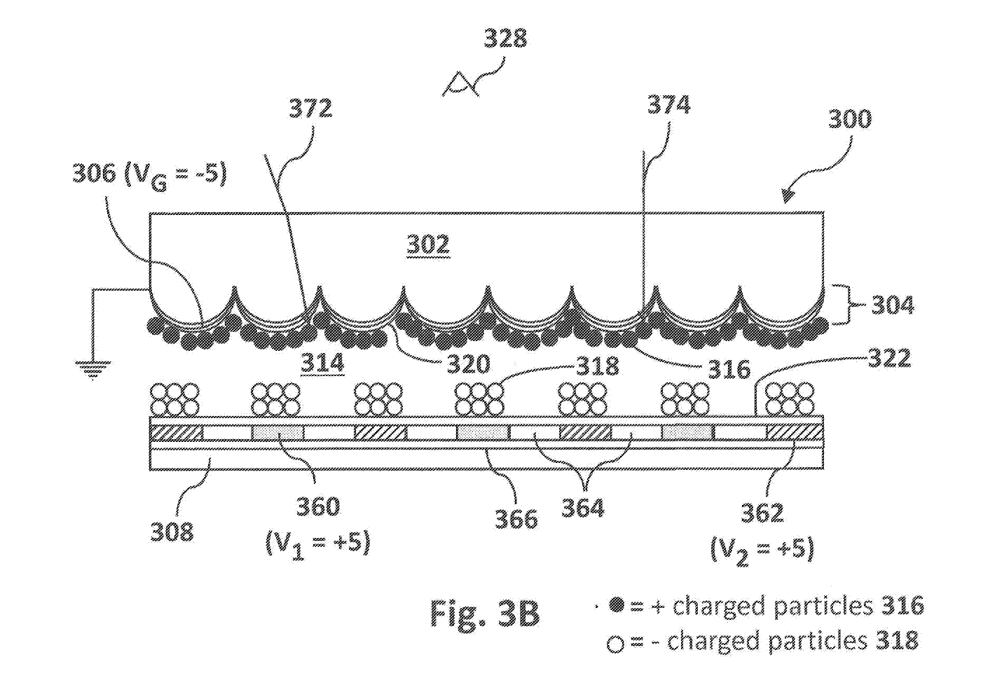

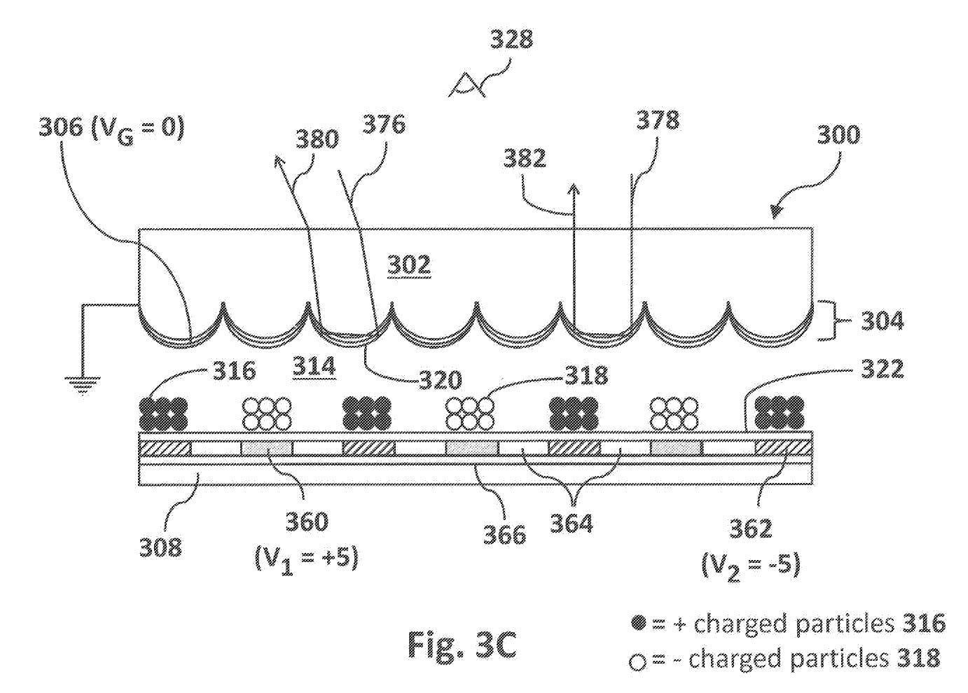

FIG. 3A schematically illustrates a cross-section of a portion of a total internal reflection image display comprising oppositely charged particles, interdigitated rear electrodes and a reflective layer in a first optical state according to one embodiment of the disclosure. Display 300 in FIG. 3A is similar to displays 100 and 200 explained in preceding paragraphs but with differences in the design of the rear electrodes. Display 100 has a first and second electrode in each pixel. Display 200 contains a plurality of more than two electrodes each of 240 and 242 in a single pixel in an array. Display 300 may also consist of a plurality of at least two electrodes, 360 and 362, that may be supported by a rear support layer 308. Electrodes 360 are shaded and electrodes 362 are highlighted by crosshatched lines in FIGS. 3A-C. Further, a transparent region 364 may be located between electrodes 360 and 362 that allows light rays to pass through. In an exemplary embodiment, region 364 may be glass, plastic or other substantially transparent material. In other embodiments, region 364 may instead be devoid of any material. Region 364 may also be made of a highly reflective filler material. Display 300 may further comprise a light reflective layer 366. Reflective layer 366 may be situated between the rear support layer 308 and the layer containing the plurality of electrodes 360, 362 and transparent region 364. A first plurality of electrodes 360 may be controlled by a first transistor and a second plurality of electrodes 362 may be controlled by a second transistor. Each plurality of electrodes, 360 or 362, may consist of more than two electrodes and may be interdigitated. The width of electrodes 360, 362 may decrease as the number of electrodes increases per each pixel while keeping the dimensions of the pixel constant.

Multiple electrodes within each pixel may provide an additional advantageous feature of the display design in FIG. 3A. Multiple electrodes may lead to decreased lateral electric fields within the cavity containing medium 314 and mobile particles 361, 318. Reducing the lateral electric fields may reduce lateral movement and migration of the particles. This may lead to more uniform display performance. The cavity formed between reflective front electrode 306 and rear electrodes 360, 362 and transparent region 364 may further comprise spacer units (not shown) such as beads to control the size of the gap between the front and rear electrodes.

The space or region between rear electrodes 360 and 362 and the reflective layer 366 provides an additional advantageous feature of the display design illustrated in FIG. 3A. Conventional TIR image displays with front sheets comprising convex protrusions such as hemispherical protrusions, suffer from “dark pupil” problem. The reflectance of the display may be reduced as incident light rays may pass through the dark pupil region at the center of each protrusion instead of being totally internally reflected. In the invention described herein, light rays that may pass through the dark pupil regions may be reflected by reflective layer 166. Reflected light rays may then be reflected back towards viewer 328 which may enhance the reflectance of display 300. Regions 364 between the rear electrodes 360 and 362 may further be aligned or registered with the convex protrusions. For example, region 364 may align with a single hemispherical protrusion or row of hemispherical protrusions.

The exemplary embodiment of display 300 may further include an optional dielectric layer 320 located on the surface of transparent front electrode 306 and disposed between transparent front electrode 306 and medium 314. FIG. 3A illustrates a dielectric layer 322 on the surface of the rear electrodes 360, 362. Dielectric layer 322 may also be located on transparent region 364 in display 300 such that the dielectric layer is disposed between the rear electrodes 360, 362 and transparent region 364 and medium 314. Having a dielectric layer on the rear electrodes may be optional and may depend on the composition of the rear electrodes. The dielectric layers may each be a uniform layer of at least about 20 nanometers in thickness. Dielectric compounds may be organic or inorganic in type. The most common inorganic dielectric material is silicon dioxide commonly used in integrated chips. Organic dielectric materials are typically polymers such as polyimides, fluoropolymers, polynorbornenes and hydrocarbon-based polymers lacking polar groups. In an exemplary embodiment, the dielectric layers comprises parylene. In another embodiment the dielectric layers comprise a halogenated parylene. Other inorganic or organic dielectric materials or combinations thereof may also be used.

The dielectric layers may each have a thickness of at least 80 nanometers. In an exemplary embodiment, the thickness is about 80-200 nanometers. Advantageously, parylene has a low dielectric constant and may be made as thin as 20 nanometers without having pinhole leakage paths. Such features may contribute to display structures having a comparatively high capacitance per unit area. The high capacitance means that the required number per unit area of charged mobile particles may be attracted to the parylene at a lower voltage than if the thickness was higher or if the dielectric constant was lower.

Referring again to FIG. 3A, the display 300 shows a pixel of the display in a first optical state. The optical state may be created by absorption of light rays by the particles 318 with a negative charge polarity and with a first optical characteristic. In this state, the electrophoretically mobile particles 316 with a positive charge polarity may be moved under the influence of an applied voltage bias near dielectric layer 322 adjacent to the plurality of rear electrodes 360, 362. Ideally, the plurality of electrodes 360 and 362 may be interdigitated but is not required for operation of display 300. In this example in FIG. 3A, the rear electrodes 360, 362 may have an applied voltage bias V₁ and V₂, respectively, of −5V (It should be noted that other voltage biases of varying magnitudes may be applied as −5V is used for illustrative purposes only). The negatively charged particles 318 may be moved near the front dielectric layer adjacent the grounded front electrode surface 306 that has a +5V bias (V_{G}). Front electrode 306 is located on the inward surface of transparent front sheet 302 on the surface of the plurality of protrusions 304. In this location particles 318 may enter the evanescent wave region, absorb incident light rays and frustrate TIR. This is illustrated by incident light rays 368 and 370 in FIG. 3A that may be absorbed by negatively charged particles 318 whereby the portion of the display in FIG. 3A observed by viewer 328 may exhibit the optical characteristic (i.e. color) of the negatively charged particles 318.

FIG. 3B schematically illustrates a cross-section of a portion of a total internal reflection image display comprising oppositely charged particles, interdigitated rear electrodes and a reflective layer in a second optical state according to one embodiment of the disclosure. Display 300 in FIG. 3B is the same as that described in FIG. 3A in the preceding paragraphs but illustrates how a second optical state may be formed. Display 300 in FIG. 3B shows a pixel of the display in a second optical state created by absorption of incident light rays by particles 316 with a positive charge polarity and with a second optical characteristic. In this state, the electrophoretically mobile particles 318 of a negative charge polarity may be moved under the influence of an applied voltage bias near optional dielectric layer 322 adjacent to the plurality of rear electrode surfaces 360 and 363. In the example in FIG. 3B, rear electrodes 360, 362 may have an applied voltage bias V₁ and ₂, respectively, of +5V (It should be noted that other voltage biases of varying magnitudes may be applied as +5V is used for illustrative purposes only). The particles 116 with a positive charge polarity may be moved near the front dielectric layer adjacent the grounded front electrode surface 106 that has a −5V bias (V_{G}) into the evanescent wave region such that TIR is frustrated and incident light rays may be absorbed. This is illustrated by incident light rays 372 and 374 that may be absorbed by the positively charged particles 316. Thus the portion of the display in FIG. 3B observed by viewer 328 exhibits the optical characteristic (i.e. color) of the positively charged particles 316.

FIG. 3C schematically illustrates a cross-section of a portion of a total internal reflection image display comprising oppositely charged particles, interdigitated rear electrodes and a reflective layer in a third optical state according to one embodiment of the disclosure. Display 300 in FIG. 3C is the same as that described in FIGS. 3A-B in the preceding paragraphs but exhibits a third optical state. In this state, the mobile particles 316 with a positive charge polarity may be moved under the influence of an applied voltage bias, V₂, of −5V near rear electrode 362. The mobile particles 318 with a negative charge polarity may be moved under the influence of an applied voltage bias, V₁, of +5 V near dielectric layer 322 adjacent to rear electrode 360 (rear electrodes are shaded in FIG. 3C). In this state of the display in FIG. 3C there may be no particles in the evanescent wave region near the front dielectric layer 320 adjacent the grounded front electrode 306 which has a voltage bias, V_{G}, of 0V. Incident light rays 376 and 378 may instead be totally internally reflected back towards viewer 328 as reflected light rays 380 and 382, respectively, to create a light or bright state. This is a third optical state of display 300. In this third optical state, regions 364 and reflective layer 366 may further enhance the reflectance as there are no particles in the evanescent wave region to absorb incident light rays. In this state, light rays that are not totally internally reflected may pass through the center of the protrusions of front sheet 302 and may be reflected by layer 366 back towards viewer 328.

In displays 100, 200 and 300 illustrated in FIGS. 1A-C, 2A-C and 3A-C and described in the preceding paragraphs, three optical states of each the displays have been described. It should be noted that a continuum of intermediate grey states may also be capable of being displayed by the reflective image displays described herein. For example, by varying the magnitude of the applied voltage bias and the time period the voltage bias is applied only partial frustration of TIR may be carried out by a portion of the particles.

In some embodiments, a porous reflective layer may be used in combination with the reflective image displays comprising more than two electrodes described herein. The porous reflective layer may be interposed between the front and rear electrode layers. In other embodiments, the rear electrode may be located on the surface of the porous electrode layer. The porous reflective layer may be formed of a track etched polymeric material such as polycarbonate, polyester, polyimide or some other polymeric material or glass with a thickness of at least about 10 microns. The porous nature of the film would allow for the electrophoretically mobile panicles to pass through the pores. The average diameter of the pores in the porous reflective layer may be substantially greater (e.g., about 10 times greater) than the average diameter of the mobile particles. The pores in the porous reflective layer may constitute large fraction (e.g., at least 10%) of the total surface area of the porous reflective layer to permit substantially unimpeded passage of the mobile particles through the pores.

Various control mechanisms for the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access Memory (RAM); magnetic disk storage media; optical storage media; a flash memory, etc.

In some embodiments, a tangible machine-readable non-transitory storage medium that contains instructions may be used in combination with the reflective displays comprising more than two electrodes described herein. In other embodiments the tangible machine-readable non-transitory storage medium may be further used in combination with one or more processors.

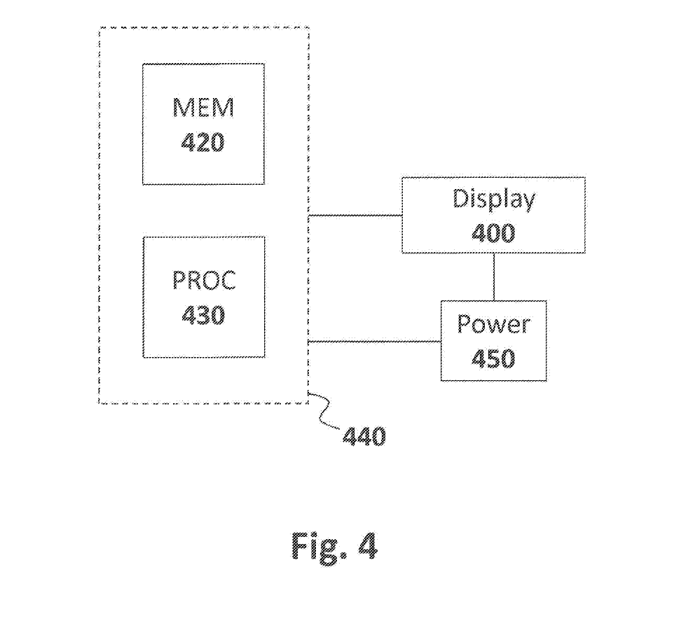

FIG. 4 shows an exemplary system for controlling a display according to one embodiment of the disclosure. In FIG. 4, display 400 is controlled by controller 440 having processor 430 and memory 420. Other control mechanisms and/or devices may be included in controller 440 without departing from the disclosed principles. Controller 440 may define hardware, software or a combination of hardware and software. For example, controller 440 may define a processor programmed with instructions (e.g., firmware). Processor 430 may be an actual processor or a virtual processor. Similarly, memory 420 may be an actual memory (i.e., hardware) or virtual memory (i.e., software).

Memory 420 may store instructions to be executed by processor 430 for driving display 400. The instructions may be configured to operate display 400. In one embodiment, the instructions may include biasing electrodes associated with display 400 (not shown) through power supply 450. When biased, the electrodes may cause movement of electrophoretic particles towards or away from a region proximal to the surface of the plurality of protrusions at the inward surface of the front transparent sheet to thereby absorb or reflect light received at the inward surface of the front transparent sheet. By appropriately biasing the electrodes, mobile light absorbing particles (e.g., particles 116 and 118 in FIGS. 1A-C, particles 216 and 218 in FIGS. 2A-C, particles 316 and 318 in FIGS. 3A-C) may be moved near the surface of the plurality of protrusions at the inward surface of the front transparent sheet into the evanescent wave region in order to substantially or selectively absorb the incoming light. Absorbing the incoming light creates a dark or colored state. By appropriately biasing the electrodes, mobile light absorbing particles (e.g., particles 116 and 118 in FIGS. 1A-C, particles 216 and 218 in FIGS. 2A-C, particles 316 and 318 in FIGS. 3A-C) may be moved away from the surface of the plurality of protrusions at the inward surface of the front transparent sheet and out of the evanescent wave region in order to reflect the incoming light. Rejecting the incoming light creates a light state.

In other embodiments, the reflective image displays comprising more than two electrodes described herein may further include at least one sidewall (may also be referred to as cross-walls). Sidewalls limit particle settling, drift and diffusion to improve display performance and bistability. Sidewalls may be located within the light modulation layer. Sidewalls may completely or partially extend from the front electrode, rear electrode or both the front and rear electrodes. Sidewalls may comprise plastic or glass. Sidewalls may create wells or compartments (not shown) to comprise the electrophoretically mobile particles. The sidewalls or cross-walls may be configured to create wells or compartments in, for example, square-like, triangular, pentagonal or hexagonal shapes or a combination thereof. The walls may comprise a polymeric material and patterned by conventional techniques including photolithography, embossing or molding. The walls help to confine the mobile particles to prevent settling and migration of said particles that may lead to poor display performance over time. In certain embodiments the displays may comprise cross-walls that completely bridge the gap created by the front and rear electrodes in the region where the liquid medium and the mobile particles resides. In certain embodiments, the reflective image display described herein may comprise partial cross-walls that only partially bridge the gap created by the front and rear electrodes in the region where the liquid medium and the mobile particles reside. In certain embodiments, the reflective image displays described herein may further comprise a combination of cross-walls and partial cross-walls that may completely and partially bridge the gap created by the front and rear electrodes in the region where the liquid medium and the mobile particles reside.

The reflective image displays comprising more than two electrodes described herein may further comprise a color filter array layer. The color array layer may comprise at least one or more of red, green and blue or cyan, magenta and yellow filters.

The reflective image displays comprising more than two electrodes described herein may further comprise a directional front light system. The directional front light system may include a light source, light guide and an array of light extractor elements on the top surface of the top sheet in each display. The directional light system may be positioned between the outward surface of the outward sheet and the viewer. The front light source may define a light emitting diode (LED), cold cathode fluorescent lamp (CCFL) or a surface mount technology (SMT) incandescent lamp. The light guide may be configured to direct light to the front entire surface of the transparent outer sheet while the light extractor elements direct the light in a perpendicular direction within a narrow angle, for example, centered about a 30° cone, towards the front sheet. A directional front light system may be used in combination with cross-walls or a color filter layer in the display architectures described herein or a combination thereof.

In other embodiments, any of the reflective image displays comprising more than two electrodes described herein may further include at least one edge seal. An edge seal may be a thermally or photo-chemically cured material. The edge seal may comprise one or more of an epoxy, silicone or other polymer based material.

In other embodiments, any of the reflective image displays comprising more than two electrodes described herein may further include a light diffusive layer to “soften” the reflected light observed by the viewer. In other embodiments a light diffusive layer may be used in combination with a front light.

In the display embodiments described herein, they may be used in such applications such as in, but not limited to, electronic book readers, portable computers, tablet computers, cellular telephones, smart cards, signs, watches, wearables, shelf labels, flash drives and outdoor billboards or outdoor signs comprising a display.

The following exemplary and non-limiting embodiments provide various implementations of the disclosure. Example 1 is directed to a method, wherein a method to display an image, comprising: receiving one or more incoming light rays at a first surface of a transparent front sheet, the front sheet having a refractive index; forming a first optical state by directing a plurality of first electrophoretically mobile particles to a region adjacent the first electrode and directing a plurality of second electrophoretically mobile particles to a region adjacent a second and a third electrodes; forming a second optical state by directing the plurality of second electrophoretically mobile particles to the region adjacent the first electrode and directing the plurality of first electrophoretically mobile particles to the region adjacent the second and the third electrodes; and forming a third optical state by directing the plurality of first electrophoretically mobile particles to a region adjacent the second electrode and directing the second plurality of electrophoretically mobile particles to a region adjacent the third electrode.

Example 2 is directed to the method of example 1, wherein the first optical state further comprises substantially or selectively absorbing the one or more incoming light rays by the plurality of first electrophoretically mobile particles thereby exhibiting the optical characteristic of the first electrophoretically mobile particles.

Example 3 is directed to the method of examples 1 or 2, wherein the second optical state further comprises substantially or selectively absorbing the one or more incoming light rays by the plurality of second electrophoretically mobile particles thereby exhibiting the optical characteristic of the second electrophoretically mobile particles.

Example 4 is directed to the method of any preceding example, further comprising receiving the one or more light rays at the first surface of the transparent front sheet and exiting the one or more light rays at a second surface of the transparent front sheet, the second surface having a plurality of hemispherical or convex protrusions.

Example 5 is directed to the method of any preceding example, further comprising receiving the one or more light rays at the first surface of the transparent front sheet and exiting the one or more light rays at a second surface of the transparent front sheet, the second surface having a plurality of hemispherical or convex protrusions.

Example 6 is directed to the method of any preceding example, further comprising biasing the first electrode at a first voltage and biasing each of the second and third electrodes at a second voltage.

Example 7 is directed to the method of any preceding example, further comprising biasing the first electrode at a first voltage, biasing the second electrode at a second voltage and biasing the third electrode at a third voltage.

Example 8 is directed to the method of any preceding example, further comprising providing the second and the third biases substantially opposite in polarity.

Example 9 is directed a multi-electrode display device, comprising: a transparent front sheet to receive one or more incoming light rays at a first surface thereof, the front sheet having a refractive index; a first electrode positioned proximal to the front sheet; a rear support facing the first electrode and forming a cavity therebetween; a second electrode positioned adjacent to the cavity; a third electrode positioned adjacent to second electrode and the cavity; and a controller to communicate with each of the first, second and the third electrodes, the controller configured to independently activate one or more of the first, second or third electrodes to cause total internal reflection of the one or more incoming light rays through the front sheet to thereby substantially exclude the incoming light rays from the cavity or to cause frustration of total internal reflection.

Example 10 is directed to the display of example 9, wherein the second and third electrodes are positioned adjacent each other.

Example 11 is directed to the display of examples 9 or 10, wherein the second and third electrodes are positioned as an array of interdigitated electrodes.

Example 12 is directed to the display of any preceding examples, wherein at least one of the plurality of protrusions defines a hemispherical or a convex protrusion.

Example 13 is directed to the display of any preceding example, further comprising at least one of a first plurality of electrophoretically mobile particles and a second plurality of electrophoretically mobile particles, the first electrophoretically mobile particles having a first charge and the second electrophoretically mobile particles having a second charge.

Example 14 is directed to the display of any preceding example, wherein the first charge and the second charge are opposite in polarity.

Example 15 is directed to the display of any preceding example, wherein the controller is further configured to bias each of the first, second and third electrodes independently to modulate total internal reflection (TIR) by moving the first electrophoretically mobile particles adjacent to the first electrode and moving the second electrophoretically mobile particles adjacent to the second and third electrodes.

Example 16 is directed to the display of any preceding example, wherein the controller is further configured to bias each of the first, second and third electrodes independently to provide total internal reflection (TIR) by moving the first electrophoretically mobile particles adjacent the second electrode and moving the second electrophoretically mobile particles adjacent the third electrode.

Example 17 is directed to the display of any preceding example, wherein the front sheet further comprises a plurality of protrusions on a second surface thereof.

Example 18 is directed to the display of any preceding example, further comprising a dielectric layer formed over at least one of the first, second or third electrodes.

Example 19 is directed to the display of any preceding example, comprising: a transparent front sheet to receive one or more incoming light rays at a first surface and exiting the one or more light rays at a second surface thereof; a pixel having: a first electrode positioned at or near the second surface of the front sheet; a second electrode and a third electrode arranged to form a cavity with the first electrode, the first and the second electrodes arranged; and a controller to communicate with each of the first, second and the third electrodes, the controller configured to independently activate one or more of the first, second or third electrodes to cause a total internal reflection of the one or more incoming light rays through the front sheet to thereby substantially exclude the incoming light rays from the cavity or to cause frustration of total internal reflection.

Example 20 is directed to the display of any preceding example, further comprising a fluidic medium disposed in the cavity.

Example 21 is directed to the display of any preceding example, further comprising at least one of a first electrophoretically mobile particles and a second electrophoretically mobile particles disposed in the medium, the first electrophoretically mobile particles having a first charge polarity and the second electrophoretically mobile particles having a second charge polarity.

Example 22 is directed to the display of any preceding example, wherein the controller is configured to engage one or more of the first, second or third electrodes to draw the first electrophoretically mobile particles to the first electrode to cause frustration of total internal reflection of the one or more incoming light rays through the front sheet and to move the second electrophoretically mobile particles adjacent to the second and third electrodes.

Example 23 is directed to the display of any preceding example, wherein the second electrode and the third electrode are arranged to form an array.

Example 24 is directed to the display of any preceding example, further comprising a plurality of second and third electrodes arranged in a checkered pattern to form a pixel with the first electrode.

Example 25 is directed to the display of any preceding example, further comprising a dielectric layer to cover one of the first, second or third electrodes.

Example 26 is directed to the display of any preceding example, wherein the controller is configured to engage the second electrode and third electrode with substantially opposite biases.

Example 27 is directed to the display of any preceding example, wherein the controller is configured to engage the first electrode and second electrode with substantially opposite biases.

While the principles of the disclosure have been illustrated in relation to the exemplary embodiments shown herein, the principles of the disclosure are not limited thereto and include any modification, variation or permutation thereof.

What is claimed is:

1. A method to display an image, comprising:
receiving one or more incoming light rays at a first surface of a transparent front sheet, the front sheet having a refractive index;
forming a first optical state by directing a plurality of first electrophoretically mobile particles to a region adjacent the first electrode and directing a plurality of second electrophoretically mobile particles to a region adjacent a second and a third electrodes;
forming a second optical state by directing the plurality of second electrophoretically mobile particles to the region adjacent the first electrode and directing the plurality of first electrophoretically mobile particles to the region adjacent the second and the third electrodes; and
forming a third optical state by directing the plurality of first electrophoretically mobile particles to a region adjacent the second electrode and directing the second plurality of electrophoretically mobile particles to a region adjacent the third electrode.

2. The method of claim 1, wherein the first optical state further comprises substantially or selectively absorbing the one or more incoming light rays by the plurality of first electrophoretically mobile particles thereby exhibiting the optical characteristic of the first electrophoretically mobile particles.

3. The method of claim 1, wherein the second optical state further comprises substantially or selectively absorbing the one or more incoming light rays by the plurality of second electrophoretically mobile particles thereby exhibiting the optical characteristic of the second electrophoretically mobile particles.

4. The method of claim 1, wherein the third optical state further comprises totally internally reflecting the one or more incoming light rays to create a light or bright optical state.

5. The method of claim 1, further comprising receiving the one or more light rays at the first surface of the transparent front sheet and exiting the one or more light rays at a second surface of the transparent front sheet, the second surface having a plurality of hemispherical or convex protrusions.

6. The method of claim 1, further comprising biasing the first electrode at a first voltage and biasing each of the second and third electrodes at a second voltage.

7. The method of claim 1, further comprising biasing the first electrode at a first voltage, biasing the second electrode at a second voltage and biasing the third electrode at a third voltage.

8. The method of claim 1, further comprising providing the second and the third biases substantially opposite in polarity.

9. A multi-electrode display device, comprising:
a transparent front sheet to receive one or more incoming light rays at a first surface thereof, the front sheet basing a refractive index;
a first electrode positioned proximal to the front sheet;
a rear support facing the first electrode and forming a cavity therebetween;
a second electrode positioned adjacent to the cavity;
a third electrode positioned adjacent to second electrode and the cavity; and
a controller to communicate with each of the first, second and the third electrodes, the controller configured to independently activate one or more of the first, second or third electrodes to cause total internal reflection of the one or more incoming light rays through the front sheet to thereby substantially exclude the incoming light rays from the cavity or to cause frustration of total internal reflection.

10. The display of claim 9, wherein the second and third electrodes are positioned adjacent each other.

11. The display of claim 9, wherein the second and third electrodes are positioned as an array of interdigitated electrodes.

12. The display of claim 9, wherein at least one of the plurality of protrusions defines a hemispherical or a convex protrusion.

13. The display of claim 9, further comprising at least one of a first plurality of electrophoretically mobile particles and a second plurality of electrophoretically mobile particles, the first electrophoretically mobile particles having a first charge and the second electrophoretically mobile particles having a second charge.

14. The display of claim 13, wherein the first charge and the second charge are opposite in polarity.

15. The display of claim 13, wherein the controller is further configured to bias each of the first, second and third electrodes independently to modulate total internal reflection (TIR) by moving the first electrophoretically mobile particles adjacent to the first electrode and moving the second electrophoretically mobile particles adjacent to the second and third electrodes.

16. The display of claim 13, wherein the controller is further configured to bias each of the first, second and third electrodes independently to provide total internal reflection (TIR) by moving the first electrophoretically mobile particles adjacent the second electrode and moving the second electrophoretically mobile particles adjacent the third electrode.

17. The display of claim 9, wherein the front sheet further comprises a plurality of protrusions on a second surface thereof.

18. The display of claim 9, further comprising a dielectric layer formed over at least one of the first, second or third electrodes.

19. A multi-electrode display device, comprising:
a transparent front sheet to receive one or more incoming light rays at a first surface and exiting the one or more light rays at a second surface thereof;
a pixel having:
a first electrode positioned at or near the second surface of the front sheet;
a second electrode and a third electrode arranged to form a cavity with the first electrode, the first and the second electrodes arranged; and
a controller to communicate with each of the first, second and the third electrodes, the controller configured to independently activate one or more of the first, second or third electrodes to cause a total internal reflection of the one or more incoming light rays through the front sheet to thereby substantially exclude the incoming light rays from the cavity or to cause frustration of total internal reflection.

20. The display of claim 19, further comprising a fluidic medium disposed in the cavity.

21. The display of claim 20, further comprising at least one of a first electrophoretically mobile particles and a second electrophoretically mobile particles disposed in the medium, the first electrophoretically mobile particles having a first charge polarity and the second electrophoretically mobile particles having a second charge polarity.

22. The display of claim 21, wherein the controller is configured to engage one or more of the first, second or third electrodes to draw the first electrophorectically mobile particles to the first electrode to cause frustration of total internal reflection of the one or more incoming light rays through the front sheet and to move the second electrophoretically mobile particles adjacent to the second and third electrodes.

23. The display of claim 19, wherein the second electrode and the third electrode are arranged to form an array.

24. The display of claim 19, further comprising a plurality of second and third electrodes arranged in a checkered pattern to form a pixel with the first electrode.

25. The display of claim 19, further comprising a dielectric layer to cover one of the first, second or third electrodes.

26. The display of claim 19, wherein the controller is configured to engage the second electrode and third electrode with substantially opposite biases.

27. The display of claim 19, wherein the controller is configured to engage the first electrode and second electrode with substantially opposite biases.
